(19) United States
(12) Patent Application Publication
(10) Pub. No.: US 2020/0215860 A1
(43) Pub. Date: Jul. 9, 2020

(54) BICYCLE TRACTION LOOPS

(71) Applicant: Michael D. Erickson, Des Moines, IA (US)

(72) Inventor: Michael D. Erickson, Des Moines, IA (US)

(21) Appl. No.: 16/240,452

(22) Filed: Jan. 4, 2019

(51) Int. Cl. B60C 27/02

(52) U.S. Cl. CPC B60C 27/0223; B60C 2200/12; B60C 27/0261

(57) ABSTRACT

Illustrative embodiments of systems and methods for improving traction of a bicycle are disclosed. The invention described are traction loops comprised of a strap having projections extending therefrom. The loops are fastened around the width of the tire using a fastening device. The loops may be easily applied and removed to provide the rider with flexibility to use the loops on slicker surfaces and remove them when riding on drier surfaces. The loops may further be easily stored on the bike when not in use.

### TECHNICAL FIELD

The present disclosure relates, generally, to bicycle accessories and, more particularly, to systems and methods for improving traction in bicycles.

### BACKGROUND

Bicycling is a popular activity, and its popularity has increased significantly in recent years. While most people confine their cycling to warmer climates and/or the warmer months of the year, many have sought ways to continue their cycling into the colder, and icier, winter months. The benefits of winter cycling are numerous and include the fact that you have to work out harder and therefore burn more calories in the colder weather to offset the effects of heavier clothes, heavier bike, heavier gear, etc. Further, maintaining biking activities through the winter months makes the transition into spring biking season easier.

While the benefits of winter cycling are numerous, so are the obstacles, the most obvious of which are slippery, icy roads and the hazards associated therewith. Preferred tire width depends upon the conditions. While narrow tires carve into soft, new snow and rest on the surface underneath, wider tires ride on top of packed snow, and are less likely to be diverted by an uneven surface. “Fatbikes” with ultra-wide tires are becoming popular for riding on packed snow. In addition, conventional bike tires can be replaced with studded tires to increase traction when riding on ice or packed snow.

While fatbikes and studded tires work well on ice and packed snow, they are less desirable for use during warmer and/or dryer riding conditions. In this regard, the wider and/or studded tires tend to add more resistance while riding. Further, studded tires can quickly become worn down if ridden on regular roads and concrete surfaces. Although these features work well for riding on ice and snow, they cannot easily be “swapped out” if, for instance, the rider does not intend to remain on ice and snow for the entirety of the ride. Instead, the rider must usually commit to remaining on the ice and snow once she commits to using fatbikes and/or studded tires for the ride.

There is therefore a need in the art for the present invention.

### SUMMARY

According to one aspect, the bike traction loops may comprise one or more straps or belts that can be wrapped around the rims of one or more of the bicycle wheels. Each of the straps in turn include one or more studs or cleats to provide traction.

The traction loops of the invention can be easily applied or removed from the bicycle wheels by wrapping the straps around the tire and rims and between the spokes of the bicycle wheels. The straps can be expanded or narrowed to fit any size bicycle tires on any type of bike, including fat bikes, tandem bikes, road bikes, mountain bikes, etc. In addition, the traction loops are lightweight and may be easily carried by the user on their rides to be easily applied or removed depending upon the terrain. In addition, the biker can tailor the degree of resistance provided by the traction loops by applying more or less of the loops to the wheels. The invention can be further modified to include more or less studs or cleats on each strap for additional or less traction.

### BRIEF DESCRIPTION OF THE DRAWINGS

The detailed description particularly refers to the following figures, in which:

FIG. 1 is a perspective view of a bicycle showing a number of traction loops removably applied to the tires.

FIG. 2 is a perspective view of a traction loop removed from the tire, shown in fastened format.

FIG. 3 is a top elevational view of the traction loop removed from the tire, shown in unfastened format.

FIG. 4 is a bottom elevational view of the traction loop, shown in unfastened format.

FIG. 5 is a perspective view of the traction loop shown applied to a bicycle tire.

FIG. 6 is a side view of traction loops in accordance with the invention.

Where considered appropriate, reference labels have been repeated among the figures to indicate corresponding or analogous elements.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

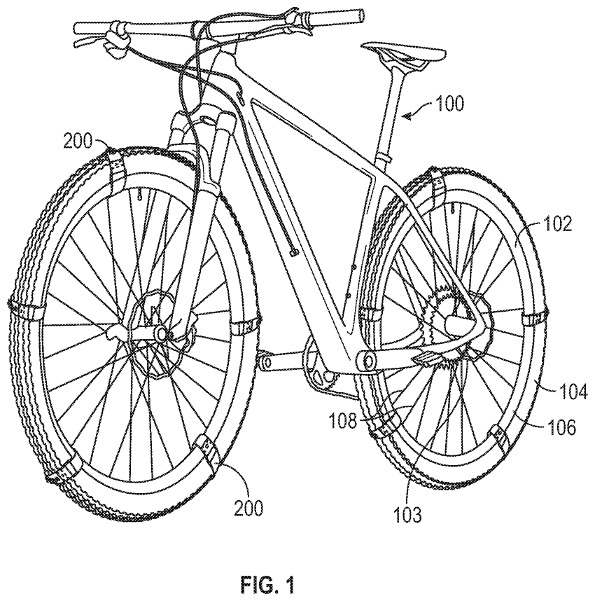

The traction loops of the invention are shown as a bicycle 100 accessory. One illustrative example of a bicycle 100 is shown in FIG. 1. Referring to FIG. 1, a bicycle 100 is shown. The bicycle includes wheels 102 covered by tires 104, whereby each of the wheels 102 further includes a hub 103 having spokes 108 extending radially therefrom rims 106 and spokes 108. While the invention is specifically described with respect to its use with a bicycle, it is to be understood that the traction loops of the invention may likewise be used with other “cycles”, such as tricycles, unicycles, that also include a “rim” to which the traction loops can be fastened, as more fully described below.

The traction loops 200 of the invention include projections 210 attached to and/or extending from a belt or strap 220 that is used to attach the traction loops 200 to the wheels 102 of the bicycle 100. The projections 210 serve to provide friction between the surface or tires 104 of the bicycle wheels 102 and an icy or slippery surface of the road (not shown). The projections 210 may include any type of cleat, stud, spike, etc. that can be used to provide additional friction on an icy or snowy surface. The projections 210 can be of any size or number, depending upon the level of friction the user desires. For instance, more and thicker/taller projections 210 would provide more friction while less and shorter/thinner projections would provide less friction. In addition, the projections 210 can form a design or graphic if desired, so long as it also provides the requisite traction for the tires 104.

The projections 210 can be made of one or more various materials including metal, rubber, plastic, wood, etc. The projections 210 themselves can include ridges or other textured surfaces to improve the degree of traction on the surface. The projections 210 should be sufficiently sturdy to uphold the weight of a biker as well as the weight of the bike itself while also providing traction on the surface of the road or ground upon which the biker is riding. Persons skilled in the art can readily understand the types of projections 210 that would work for the purposes of the invention.

As noted, the projections 210 are attached or connected to a belt or strap 220, whereby the belt is then looped or wrapped around one or more of the bicycle wheels/tires 102. In this regard, the projections 210 may be attached to the strap 220 by conventional means, such as by bolts, screws, glue, Velcro, by sewing the projections 210 into the strap, etc. Alternatively, the strap 220 and projections 210 can be a unitary article of manufacture.

The strap 220 can be likewise be manufactured from a variety of materials including, but not limited to, fabric, nylon, polypropylene, polyester, ribbon, plastic, metal, leather, etc. The main requirements for the strap 220 in this regard is that it be at least somewhat flexible so it can be wrapped around and secured to the wheels 102 of the bicycle 100, and should further be sufficiently sturdy so as to remain fastened to the wheels 102 while the bicycle 100 is moving. The straps 220 may also be made of an elastic material to provide better conformity of the straps 220 to the wheels 102 once they are attached. In one embodiment, the straps 200 may be manufactured in a variety of colors with different types of designs/logos so as to add an ornamental feature to the bicycle 100. The straps 200 may further include conventional bicycle safety features including, but not limited to, lights, reflectors, etc.

In a preferred embodiment, the straps 220 are made of a material which allow them to be easily folded or creased so they may be stored, for example, in a storage unit on the bicycle 100 itself. In another preferred embodiment, the straps 220 are fairly light and portable so they do not add a large amount of added weight or bulk to the bicycle 100 while being stored and carried by the user. Persons skilled in the art would readily understand the types of materials and design features of a strap suitable for use in the invention.

The straps 220 may be fastened to the wheels 102 of the bicycle 100 using a variety of known means, including buckles, straps, Velcro, slides, loops, snap hooks, ratchets, etc. to insure the straps 200 remain secured to the bicycle 100 while the bicycle 100 is in motion, and to further insure that the projections 210 remain in contact with the riding surface during the ride. Fastening hardware 224, if included, may also be made of various materials that may be the same or different from the material of the straps 220. In contrast to the straps 200, however, the hardware 224 material is not required to be flexible and may include, but is not limited to, metal, wood, plastic, etc. In one embodiment, the fastening hardware 224 is made of a rigid material, such as metal or wood.

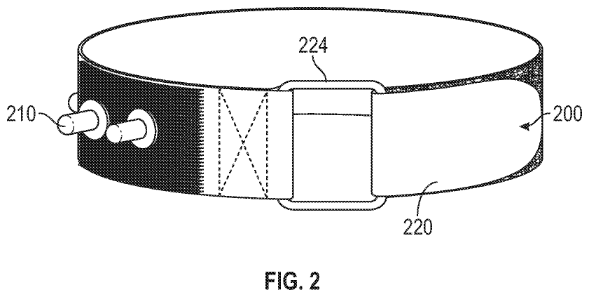

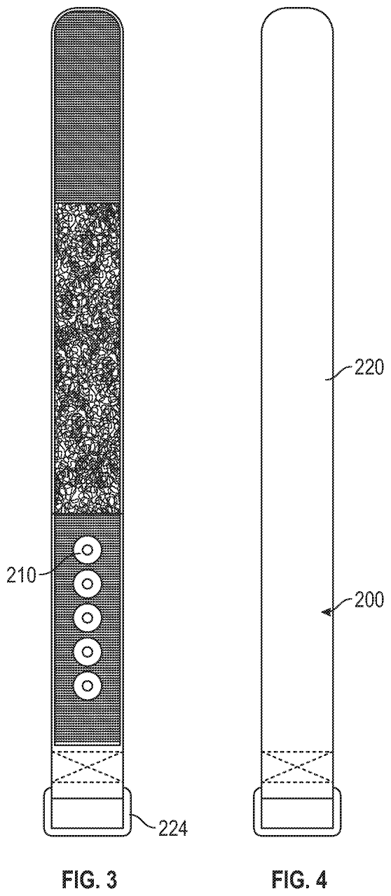

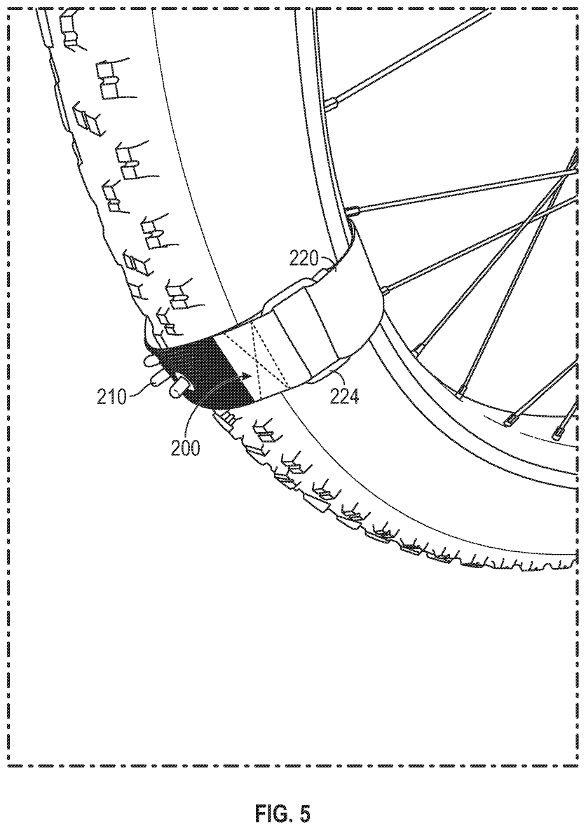

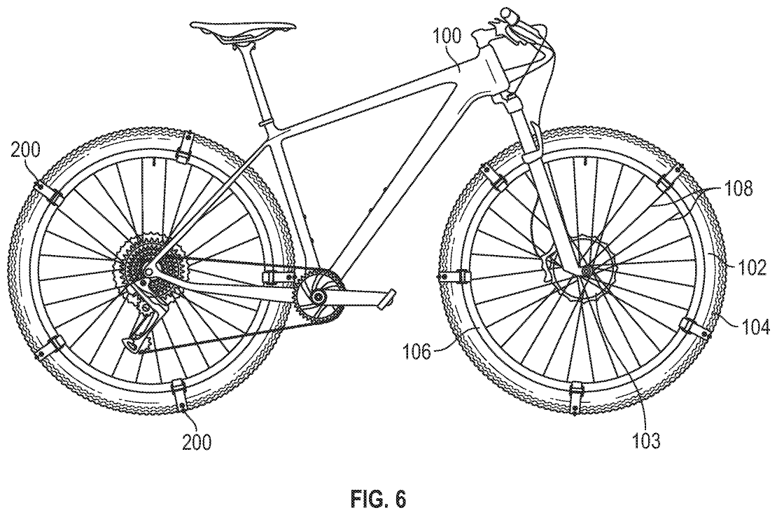

One illustrative of the traction loops 200 of the invention is shown in FIGS. 1-6. In this embodiment, the traction loops 200 include a flexible cloth strap 220 with buckle back ring hardware 224. The strap 220 has several rivet projections 210 to provide traction between the tire 104 and the surface upon which the user is riding.

When applying the traction loops 200 to the bicycle, one or more of the loops 200 may be applied to overlay at least a portion of one or more wheels 102 of the bicycle 100. In this regard, the loop 200 is wrapped around the wheel 102 so that it is not parallel to the vertical plane of the wheel. In one embodiment, the loops 200 are in a direction generally traverse to the vertical plane of the wheels 102. In another embodiment, the loops 200 are perpendicular to the vertical plane of the wheels 102.

The loops 200 are applied to the wheel 102 by passing the strap 220 through the open area of the wheel 102 and in between the spokes 108, with the projection(s) 210 facing outwardly from the wheel 102 so the projection(s) 210 will contact the riding surface when the bicycle 100 is in motion. If the bicycle 100 does not have spokes 108 the strap 220 may simply be secured in the same manner in a generally perpendicular manner around the wheel 102 or tire 104. The strap 220 may be threaded in between spokes 108 so that the loop 200 is perpendicular or nearly perpendicular to the vertical plane of the wheel 102, or may be threaded in a more diagonal direction between spokes 108 of the wheel 102. The only requirement of the loop 200 is that it be wrapped or looped around the width (not the circumference) of the wheel 102 or tire 104, i.e. from rim to tread.

The strap 220 is fastened appropriately depending upon the fastening mechanism employed and such that the strap 220 is sufficiently secure to prevent it from falling off of the wheel 102. Once finished with the loops 200, the user can remove them using the opposite procedure, whereby the fastening mechanism of the strap 220 is undone and the strap 220 unwrapped and removed from the wheel 202.

In practice, the user can carry one or more traction loops 200 with him or her when going on a bike ride to be applied to the bicycle wheels 102 if and when the user encounters an icy surface. Once applied, the user can leave the traction loops on the bicycle 100 while remaining on the icy surface. If and when the user leaves the icy surface and no longer needs or wants the additional traction provided by the traction loops 100, as already described, the traction loops 100 may be easily removed by the user and stored in a conventional bicycle tote bag or basket.

There are a plurality of advantages of the present disclosure arising from the various features of the systems, apparatus, and methods described herein. It will be noted that alternative embodiments of the systems, apparatus, and methods of the present disclosure may not include all of the features described yet still benefit from at least some of the advantages of such features. Those of ordinary skill in the art may readily devise their own implementations of the systems, apparatus, and methods that incorporate one or more of the features of the present disclosure and fall within the spirit and scope of the present invention as defined by the appended claims.

1. Traction loops for improving traction of a cycle with a riding surface, said cycle having one or more wheels, comprising:
at least one strap adapted for application around the wheel of the cycle in a manner such that the strap is not parallel to the vertical plane of the wheel;
one or more projections extending from the strap to improve traction between the wheel of the cycle and the riding surface; and
means for fastening the strap to the wheel.

2. The traction loops of claim 1 adapted for application around the width of the wheel.

3. The traction loops of claim 1 whereby the projections are selected from the group consisting of cleats, studs, rivets, and spikes.

4. The traction loops of claim 1 whereby the straps are comprised of a flexible material.

5. The traction loops of claim 1 whereby the fastening means are selected from the group consisting of buckles, straps, Velcro, slides, loops, snap hooks, and ratchets.

6. The traction loops of claim 1 comprising two or more projections.

7. The traction loops of claim 1 whereby the strap is elastic.

8. A method of improving traction of a cycle having at least one wheel comprising:
wrapping at least one traction loop around the wheel of the cycle in a manner such that the traction loop is not parallel to the vertical plane of the wheel;
said traction loop comprising a strap having one or more projections extending therefrom to improve traction between the wheel of the cycle and the riding surface;
and further providing that the strap is wrapped around the wheel in a manner such that the projections contact a riding surface of the cycle to improve traction between the wheel of the cycle and the riding surface.

9. The method of claim 8 whereby the wrapping step comprises wrapping the strap around the width of the wheel.

10. The method of claim 8 further including the step of fastening the strap around the wheel.

11. The method of claim 8 further including the step of removing the loop from the wheel by unfastening the strap.

12. The method of claim 8 further including the step of storing the loop in a storage container attached to the cycle when the loop is not attached to the wheel.

13. The method of claim 8 whereby the strap is looped between spokes of the wheel.

14. The method of claim 10 whereby the strap is fastened by buckling.

15. The method of claim 10 whereby the strap is fastened with Velcro.

16. A method of improving traction of a cycle comprising: applying the traction loops of claim 1 to the cycle.

17. A method according to claim 16 whereby the cycle is selected from the group consisting of a bicycle, a tricycle, and a unicycle.

18. A cycle having improved traction comprising: a cycle; and the traction loops of claim 1.

19. The cycle of claim 18 whereby the traction loops are not parallel to the vertical plane of the wheel.

20. The cycle of claim 18 whereby the traction loops are generally traverse to the vertical plane of the wheels.
